(19) United States
(12) Patent Application Publication
(10) Pub. No.: US 2010/0270276 A1
(43) Pub. Date: Oct. 28, 2010

(54) System and Method for Repairing Hermetic Solder Seals in RF Electronic Assemblies

(76) Inventors: Douglas E. Cookson, Merrimack, NH (US); Jonathan D. Kervin, Townsend, MA (US)

Correspondence Address: BAE SYSTEMS, PO BOX 868, NASHUA, NH, 03061-0868, US

(21) Appl. No.: 12/429,450

(22) Filed: Apr. 24, 2009

(51) Int. Cl. B23K 1/005; B23K 31/02

(52) U.S. Cl. 219/121.66; 228/119

(57) ABSTRACT

The system contains a laser beam source and a work piece having a soldered joint. A work piece holder holds the work piece at an angle relative to the laser beam source. A crack is formed in a soldered joint of the work piece. The laser beam source is positioned approximately centered on the crack. At least one temperature sensitive electronic element is contained within the work piece.

### STATEMENT REGARDING FEDERALLY SPONSORED RESEARCH OR DEVELOPMENT

This invention was made in part with Government support under contract number FA8611-06-C-2899. The Government has certain rights in the invention.

### FIELD

The present disclosure is generally related to hermetic solder seals, and more particularly is related to a system and method for repairing hermetic solder seals in RF electronic assemblies.

### BACKGROUND

Many RF electronic assemblies are packaged in metal housings that are hermetically sealed using a laser welding process. These packages may be, for example, aluminum, titanium, or Kovar. These assemblies may use connectors that are laser welded to the metal housing and/or connectors that are soldered to the metal housing. The connectors that are soldered are usually soldered to the metal housing use a high temperature solder, such as gold-tin eutectic solder, for example. Reflow is achieved in an inert environment with assemblies reaching temperatures above 280 degrees Celsius, an accepted reflow temperature of gold-tin eutectic solder in a non-direct heating environment.

Following the housing/connector integration process, substrates and components are installed in the housing. During, and/or after installation of the substrates and components, cracks may develop between the metal housing and the connectors. FIG. 1 is a front view of a crack 12 between a connector 14 and a housing 16 in an RF assembly 10. As can be seen in FIG. 1, the crack 12 is formed in an area that had been hermetically sealed with solder 18. In many instances, the substrates and components react adversely at the 280 degree Celsius, limiting the possibility of soldering the cracks using the original soldering techniques. In fact, if the crack is discovered after installation, the assembly is often discarded because of the lack of a cost-effective and component-safe means for repairing the crack.

Thus, a heretofore unaddressed need exists in the industry to address the aforementioned deficiencies and inadequacies.

### SUMMARY

Embodiments of the present disclosure provide a system and method for repairing hermetic solder seals in RF electronic assemblies. Briefly described, in architecture, one embodiment of the system, among others, can be implemented as follows. The system contains a laser beam source and a work piece having a soldered joint. A work piece holder holds the work piece at an angle relative to the laser beam source. A crack is formed in a soldered joint of the work piece. The laser beam source is positioned approximately centered on the crack. At least one temperature sensitive electronic element is contained within the work piece.

The present disclosure can also be viewed as providing methods for repairing hermetic solder seals in RF electronic assemblies. In this regard, one embodiment of such a method, among others, can be broadly summarized by the following steps: discovering a crack between a connector and a housing that are joined with solder; and heating solder within the crack using a laser to heat an area local to the crack to a heated temperature at least approximately equal to a reflow temperature of the solder.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the invention can be better understood with reference to the following drawings. The components in the drawings are not necessarily to scale. Instead emphasis is being placed upon illustrating clearly the principles of the present disclosure. Moreover, in the drawings, like reference numerals designate corresponding parts throughout the several views.

FIG. 1 is a front view of a crack between a connector and a housing in an RF assembly.

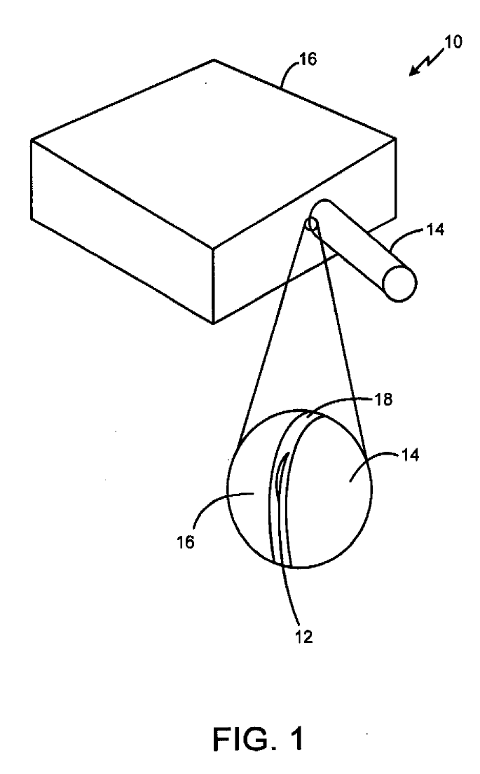

FIG. 2 is an illustration of a prospective view of a system for repairing an RF assembly, in accordance with a first exemplary embodiment of the present disclosure.

FIG. 3 is an illustration of a side view of the RF assembly of FIG. 2, in accordance with the first exemplary embodiment of the present disclosure.

FIG. 5 is an illustration of a flowchart illustrating a method for repairing cracks in soldered connections utilizing the system of FIG. 2, in accordance with the first exemplary embodiment of the present disclosure.

FIG. 6 is an illustration of a flowchart illustrating a reflow process for repairing hermetic solder seals in RF electronic assemblies, in accordance with a second exemplary embodiment of the present disclosure.

### DETAILED DESCRIPTION

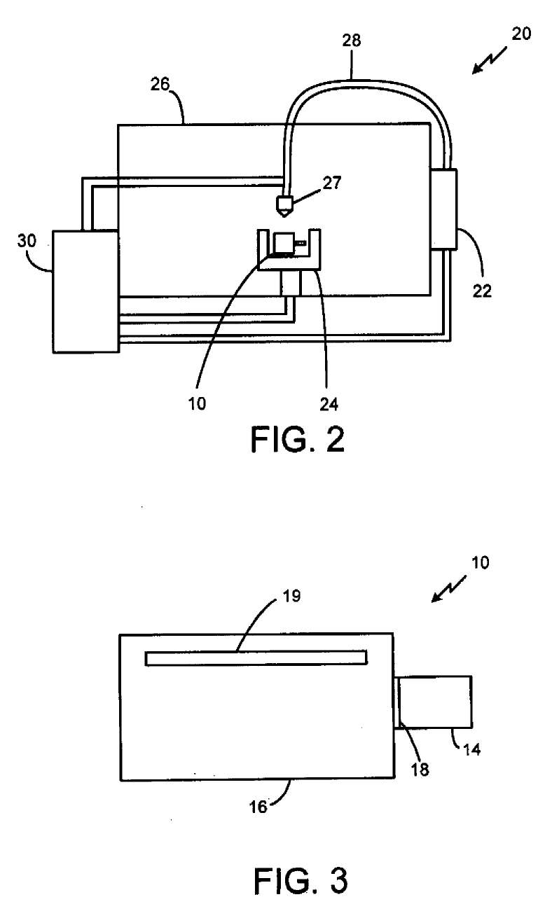

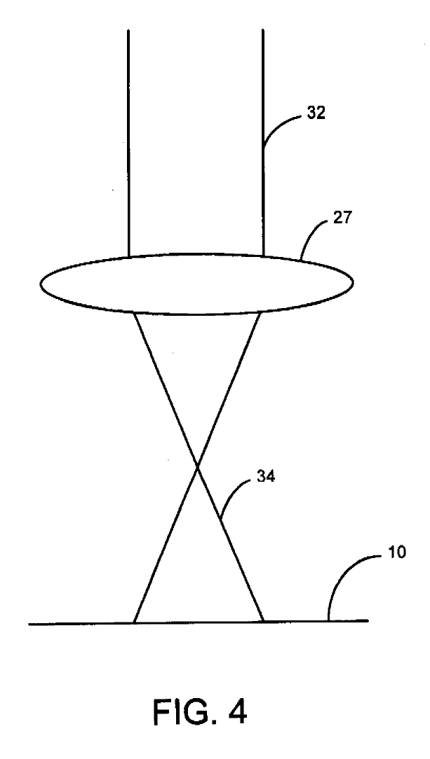

FIG. 2 is an illustration of a prospective view of a system 20 for repairing an RF assembly 10, in accordance with a first exemplary embodiment of the present disclosure. FIG. 3 is an illustration of a side view of the RF assembly 10 of FIG. 2, in accordance with the first exemplary embodiment of the present disclosure. The system 20 contains a laser beam source 22 and a work piece, such as an RF assembly 10, having a joint sealed with solder 18. A work piece holder 24 holds the RF assembly 10 at an angle relative to the laser beam source 22. A crack 12 is formed in the joint sealed with solder 18 of the RF assembly 10. The laser beam source 22 is positioned approximately centered on the crack 12. A sidewall of the RF assembly 10 of FIG. 3 is removed to show at least one temperature sensitive electronic element 19 is contained within the RF assembly 10.

The laser beam source 22 may be any type of laser beam source known by those having ordinary skill in the art that is capable of locally heating a work piece to temperatures of at least approximately 280 degrees Celsius. A solid state, pulsed Nd:YAG laser has been utilized to practice the invention. The laser beam source may be capable of firing a laser beam having a wavelength of approximately between 1050 nanometers and 1080 nanometers. The system 20 may include a controlled atmosphere chamber 26, within which the work piece holder 24 may be mounted. The controlled atmosphere chamber 26 may be filled with an inert gas, such as nitrogen, to limit oxidation. The controlled atmosphere chamber 26 may also contain helium, which is useful for determining the integrity of a hermetic solder seal. The laser beam source 22 may be located outside of the controlled atmosphere chamber 26 with a fiber optic cable 28 having focusing optics 27 communicating output from the laser beam source 22 to the work piece holder 24 and, more specifically, the RF assembly 10 mounted thereon.

A laser system controller 30 accessible outside the controlled atmosphere chamber 26 may mechanically control movement of the work piece holder 24, and/or the focusing optics 27, or any other element of the system 20, to center the output of the laser beam source 22 on the crack 12 and/or the joint of solder 18. Centering the output of the laser beam source 22 on the housing 16 or the connector 14 may result in solder 18 reflowing away from the joint, frustrating the purpose of hermetically sealing the joint. The solder 18 may be gold-tin eutectic solder. The solder 18 may be at least eighty percent gold, by weight. The system 10 may make use of solder 18 existing around the crack 12, reflowing the solder 18 to repair the hermetic solder seal. The solder 18, and a portion of the connector 14 and housing 16 about the solder 18, may be heated to a temperature that would do damage to the temperature sensitive electronic element 19 if generalized to the entire RF assembly 10. Localizing the heat protects the temperature sensitive electronic element 19 from exposure to an otherwise dangerous temperature. Additional solder 18 may be tacked onto the crack 12, if needed, before engaging the system 20. The additional solder 18 may include a solder wire, a substance known to those having ordinary skill in the art.

FIG. 4 is an illustration of a view of the laser beam utilized in the system shown in FIG. 2, in accordance with the first exemplary embodiment of the present disclosure. The system 20 may utilize a machine used for laser welding. Laser welders do not utilize solder 18. However, a laser welder may have the laser system controller 30, laser beam source 22, work piece holder 24, controlled atmosphere chamber 26, and focusing optics 27 as described herein, with reference to FIG. 2. The laser beam source 22 may be defocused by increasing a distance between the focusing optics 27 and the RF assembly 10 to a distance greater than would be an acceptable distance between a laser beam source and a welding work piece for a welding application. This technique is illustrated in FIG. 4, in which the laser beam 32 is focused by the at least one of the focusing optics 27 to a focal point 34, after which it begins diverging before reaching the RF assembly 10. When welding, a work piece is held closer to the focal point 34. For reflowing solder, the RF assembly 10 may be mounted such that the laser beam 32 impacts the RF assembly 10 at least 0.1 inches from the focal point 34. By moving the RF assembly from the focal point 34, the laser beam 32 is effectively defocused.

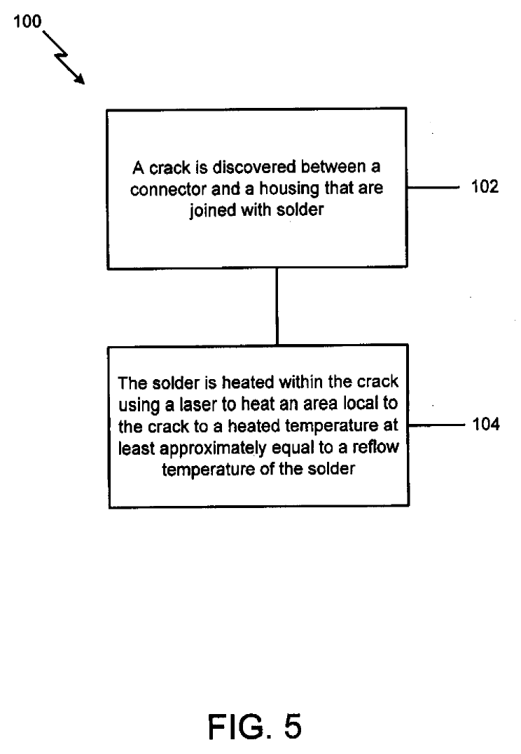

FIG. 5 is an illustration of a flowchart illustrating a method 100 for repairing cracks in soldered connections utilizing the system 20 of FIG. 2, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, a crack 12 is discovered between a connector 14 and a housing 16 that are joined with solder 18. The solder 18 is heated within the crack 12 using a laser to heat an area local to the crack 12 to a heated temperature at least approximately equal to a reflow temperature of the solder 18 (block 104).

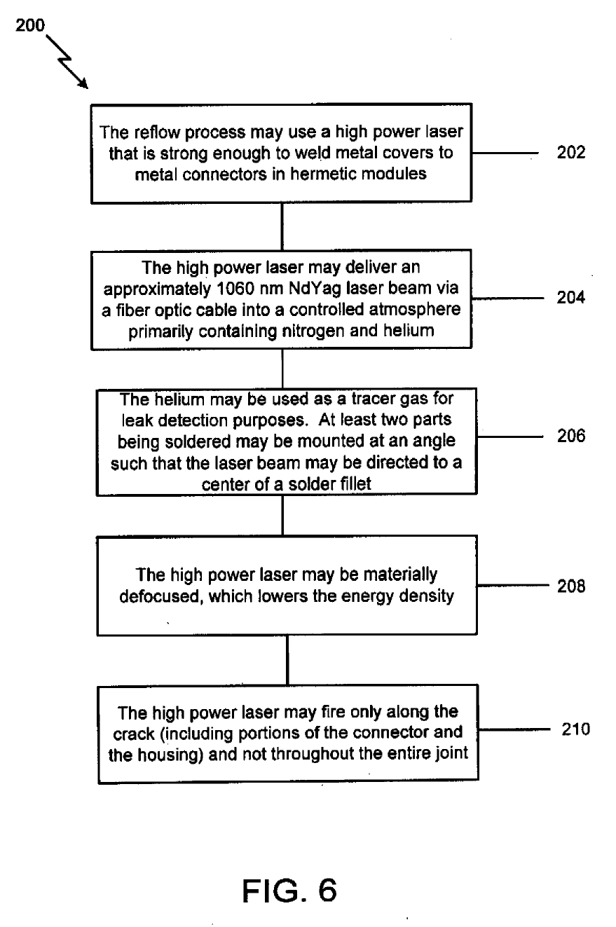

FIG. 6 is an illustration of a flowchart illustrating a reflow process 200 for repairing hermetic solder seals in RF electronic assemblies, in accordance with a second exemplary embodiment of the present disclosure. The reflow process may use a high power laser 22 that is strong enough to meld metal covers to metal connectors 14 in hermetic modules (block 202). The high power laser 22 may deliver an approximately 1060 nm Nd:YAG laser beam via a fiber optic cable 28 into a controlled atmosphere primarily containing nitrogen and helium (block 204). The helium may be used as a tracer gas for leak detection purposes. At least two parts being soldered may be mounted at an angle such that the laser beam may be directed to a center of a solder 18 fillet (block 206). The high power laser 22 may be materially defocused, which lowers the energy density (block 208). The high power laser 22 may fire only along the crack 12 (including portions of the connector 14 and the housing 16) and not throughout the entire joint (block 210).

The laser beam 22 is directed toward the center of the solder 18 fillet because being materially off-center, the solder 18 would propagate toward the target of the laser beam and leave and/or create a larger void in the solder 18 fillet. Relative to laser welding, the laser soldering is performed with a greater beam diameter and greatly reduced power density. Final solder joints wet well to both the housing 16 and the connector 14, or any two elements having a cracked solder 18 joint therebetween. No flux is required for this process. Solder wire may be tacked to the cracked area for increased solder volume when useful. This reflow process reworks cracks with no collateral damage to other elements of the RF electronic assembly.

It should be emphasized that the above-described embodiments of the present disclosure, particularly, any “preferred” embodiments, are merely possible examples of implementations, merely set forth for a clear understanding of the principles of the disclosed system and method. Many variations and modifications may be made to the above-described embodiments of the disclosure without departing substantially from the spirit and principles of the disclosure. All such modifications and variations are intended to be included herein within the scope of this disclosure and protected by the following claims.

What is claimed is:

1. A method for repairing cracks in soldered connections, the method comprising the steps of:
discovering a crack between a connector and a housing that are joined with solder; and
heating solder within the crack using a laser to heat an area local to the crack to a heated temperature at least approximately equal to a reflow temperature of the solder.

2. The method of claim 1, further comprising the step of heating the solder at atmosphere.

3. The method of claim 1, further comprising the step of heating the solder in an inert atmosphere.

4. The method of claim 1, wherein the solder further comprises gold-tin eutectic solder.

5. The method of claim 1, further comprising the step of tack welding additional solder to the crack prior to the step of heating solder.

6. The method of claim 1, wherein using the laser further comprises using a welding laser to heat the solder, and wherein the welding laser is defocused to reflow the solder.

7. The method of claim 1, further comprising using up to 20 laser pulses to heat the solder.

8. The method of claim 1, further comprising the step of submersing the connector and the housing in an atmosphere of primarily helium and nitrogen.

9. The method of claim 1, further comprising the step of approximately centering the laser on the solder, wherein the laser is fired in pulses having a wavelength of approximately 1060 nm.

10. The method of claim 1, wherein the housing and the connector are parts of an assembly having temperature sensitive electronics contained therein, and wherein heating the area local to the crack does not significantly heat the temperature sensitive electronics.

11. A system for repairing cracks in soldered connections, the system comprising:
a laser beam source;
a work piece having a soldered joint;
a work piece holder, wherein the work piece holder holds a work piece at an angle relative to the laser beam source;
a crack in a soldered joint of the work piece, wherein the laser beam source is positioned approximately centered on the crack; and
at least one temperature sensitive electronic element within the work piece.

12. The system of claim 11, further comprising a limited area about the crack that is heated by a laser beam from the laser beam source.

13. The system of claim 11, wherein the laser beam source is capable of firing a laser beam having a wavelength of approximately 1060 nm.

14. The system of claim 11, wherein the solder further comprises gold-tin eutectic solder.

15. The system of claim 11, further comprising a controlled atmosphere chamber within which the work piece holder is mounted.

16. The system of claim 11, further comprising an atmosphere of primarily helium and nitrogen.

17. The system of claim 11, further comprising a length of solder wire tacked to the crack.

18. A system for repairing cracks in soldered connections, the system comprising:
means for discovering a crack between a connector and a housing that are joined with solder; and
means for heating solder within the crack using a laser to heat an area local to the crack to a heated temperature at least approximately equal to a reflow temperature of the solder.

19. The system of claim 18, further comprising means for heating the solder in an inert atmosphere.

20. The system of claim 18, further comprising means for approximately centering the laser on the solder, wherein the laser is fired in pulses having a wavelength of approximately 1060 nm.
